(19) United States
(12) Patent Application Publication
(10) Pub. No.: US 2013/0135531 A1
(43) Pub. Date: May 30, 2013

(54) DATA PROCESSING APPARATUS AND METHOD FOR VIDEO REPRODUCTION

(71) Applicants: Shuta Ogawa, Kawasaki-shi (JP); Yoshihiro Ohmori, Ome-shi (JP)

(72) Inventors: Shuta Ogawa, Kawasaki-shi (JP); Yoshihiro Ohmori, Ome-shi (JP)

(21) Appl. No.: 13/533,787

(22) Filed: Jun. 26, 2012

(30) Foreign Application Priority Data
Nov. 29, 2011 (JP) 2011-260674

(51) Int. Cl. H04N 9/64

(52) U.S. Cl. 348/720; 348/E09.037

(57) ABSTRACT

According to one embodiment, a data processing apparatus includes a viewing information acquisition module, application setting module, and output module. The viewing information acquisition module is configured to acquire viewing information indicating a viewing state of a video reproduction apparatus. The application setting module is configured to set an application used to execute designated data processing associated with an operation of the video reproduction apparatus. The output module is configured to output a launch instruction required to launch the application set by the application setting module.

### CROSS-REFERENCE TO RELATED APPLICATIONS

This application is based upon and claims the benefit of priority from prior Japanese Patent Application No. 2011-260674, filed Nov. 29, 2011, the entire contents of which are incorporated herein by reference.

### FIELD

Embodiments described herein relate generally to a data processing apparatus, system, and method for video reproduction.

### BACKGROUND

Conventionally, it is a common practice for a video reproduction apparatus represented by a television (TV) set to make operations such as a power on/off operation and channel switching operation using a remote control unit (to be referred to as a remote controller hereinafter) using infrared communications or the like.

In recent years, applications used to operate a TV set from a mobile terminal (portable information terminal) have been provided. Such applications are programs which function on the mobile terminal, and are provided via, for example, a network.

The user can operate a TV set from the mobile terminal installed with the applications via a wireless LAN or home network. In this case, the operations of the TV set include an operation for displaying information such as TV broadcast programs on a display screen of the mobile terminal. In addition to such applications, a remote controller system which provides information such as programs from a TV set to a remote controller has been proposed.

Use of applications can improve operability of a TV set, and a variety of application functions can broaden the range of the operability of the TV set. However, a user (TV viewer) himself or herself has to judge which functions of applications are to be used in various situations. It is not easy for the user to select an optimal application function depending on the situation, and it is consequently difficult to effectively such applications.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram for explaining the arrangement of a system according to the first embodiment;

FIG. 2 is a block diagram for explaining principal part of a controller according to the first embodiment;

FIG. 3 is a view for explaining the operation of the controller according to the first embodiment;

FIG. 4 is a flowchart for explaining the operation of the controller according to the first embodiment;

FIG. 5 is a block diagram showing an application example according to the first embodiment;

FIG. 6 is a block diagram showing another application example according to the first embodiment;

FIG. 7 is a flowchart for explaining the operation of a mobile terminal according to the first embodiment;

FIG. 8 is a view for explaining a function of an application according to the first embodiment;

FIG. 9 is a view for explaining a function of an application according to the second embodiment;

FIG. 10 is a table for explaining launch conditions of applications according to the first and second embodiments;

FIG. 11 is a view for explaining a modification of the first embodiment; and

FIG. 12 is a flowchart for explaining the operation of a controller according to the second embodiment.

### DETAILED DESCRIPTION

Various embodiments will be described hereinafter with reference to the accompanying drawings.

In general, according to one embodiment, a data processing apparatus includes a viewing information acquisition module, application setting module, and output module. The viewing information acquisition module is configured to acquire viewing information indicating a viewing state of a video reproduction apparatus. The application setting module is configured to set an application used to execute designated data processing associated with an operation of the video reproduction apparatus. The output module is configured to output a launch instruction required to launch the application set by the application setting module.

[System Arrangement]

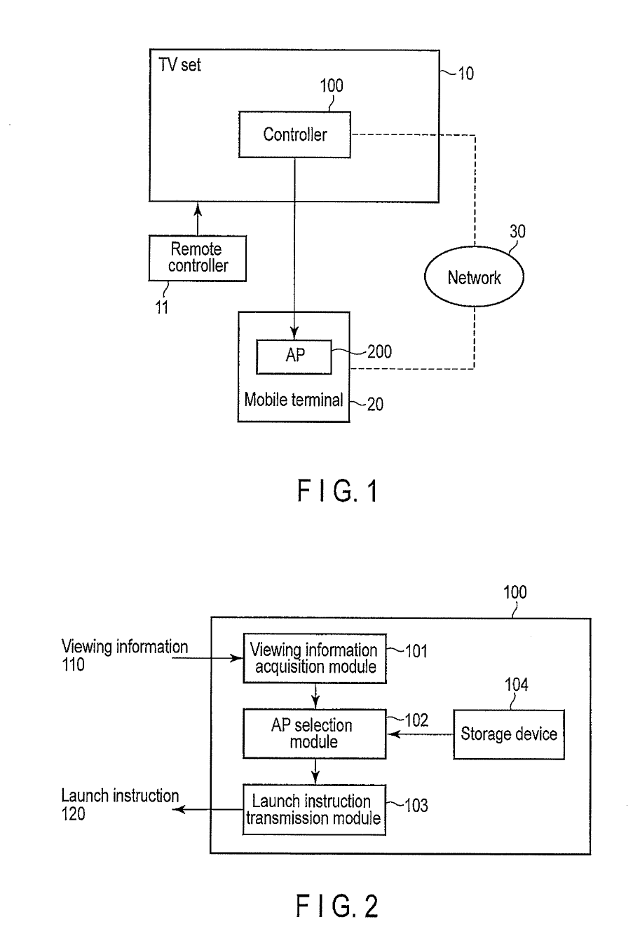

As shown in FIG. 1, a system of this embodiment includes a controller 100 incorporated in a TV set 10, a remote controller 11, a mobile terminal 20, and a network 30. In this embodiment, the TV set 10 is a digital TV. Alternatively, the TV set 10 may be a cable TV set or a video reproduction apparatus such as a personal computer having a video reproduction function (including an audio reproduction function).

The remote controller 11 has a power switch, channel switching buttons, and various command buttons of the TV set 10. The mobile terminal 20 is a portable electronic device such as a portable information terminal or cellular phone, which has data processing functions by installing and executing applications to be described later. The network 30 is a wireless LAN, home network, or the like, and executes data communications based on, for example, an IP (Internet Protocol) between the controller 100 and mobile terminal 20.

As shown in FIG. 2, the controller 100 of the first embodiment has a viewing information acquisition module 101, application (AP) selection module 102, launch instruction transmission module 103, and storage device 104. The controller 100 is a data processing apparatus including hardware and software of a computer, and implements functions of the respective modules 101 to 103 by software.

The viewing information acquisition module 101 acquires viewing information 110 indicating a viewing state (user's viewing behavior) when the user views the TV set 10. More specifically, the viewing information 110 indicates a viewing state such as a zapping behavior performed when the user frequently switches channels of TV programs, a channel number that designates a specific channel, a simple power-on operation, or the like. The viewing information acquisition module 101 generates and acquires the viewing information 110 based on, for example, an operation of the remote controller 11.

The AP selection module 102 selects an applicable application based on the viewing information 110 from the viewing information acquisition module 101 and application launch conditions. More specifically, the storage device 104 stores application information (AP information) required to specify a launch condition and application. The AP information includes an IP address of the mobile terminal 20 in which an application is installed, and an application identifier in addition to the launch condition to be described later. The AP selection module 102 selects an applicable application based on the AP information stored in the storage device 104.

Note that the storage device 104 may store only AP information of an application of one type. In this case, when the viewing information 110 matches a launch condition, the AP selection module 102 sets that application; otherwise, the module 102 does not set any application.

The launch instruction transmission module 103 outputs a launch instruction 120 required to launch the application selected (set) by the AP selection module 102. More specifically, the controller 100 transmits a packet of the launch instruction 120 onto the network 30.

As shown in FIG. 1, when the mobile terminal 20 receives the packet of the launch instruction 120 from the network 30, and installs a corresponding application 200, that application 200 is launched. Note that the application 200 is launched when it is installed in another electronic device connected to the network 30 in addition to the mobile terminal 20, as a matter of course.

The controller 100 may transmit the launch instruction 120 which limits both the mobile terminal 20 and application 200. In this case, even when an identical application 200 is installed in a plurality of mobile terminals (electronic devices), that installed in only one of these mobile terminals is launched. As a practical example, when each AP information includes information “last launch date and time”, and the launch condition includes a condition “a newest last launch date and time of all pieces of AP information”, an AP to be launched is specified according to the launch instruction 120.

[Operation of First Embodiment]

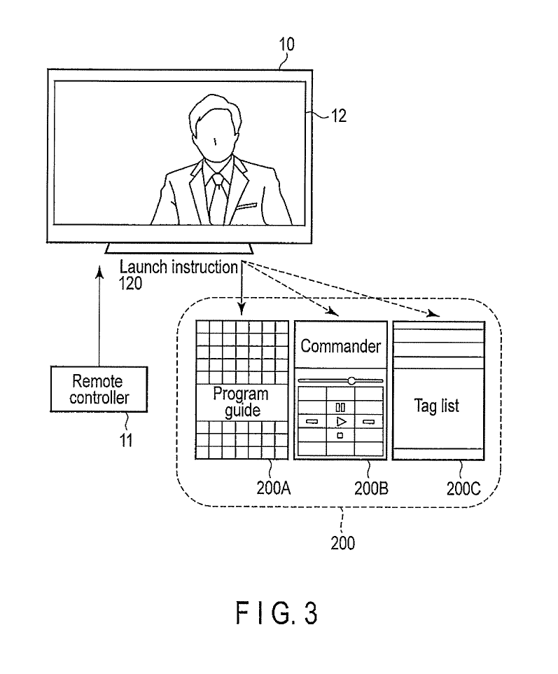

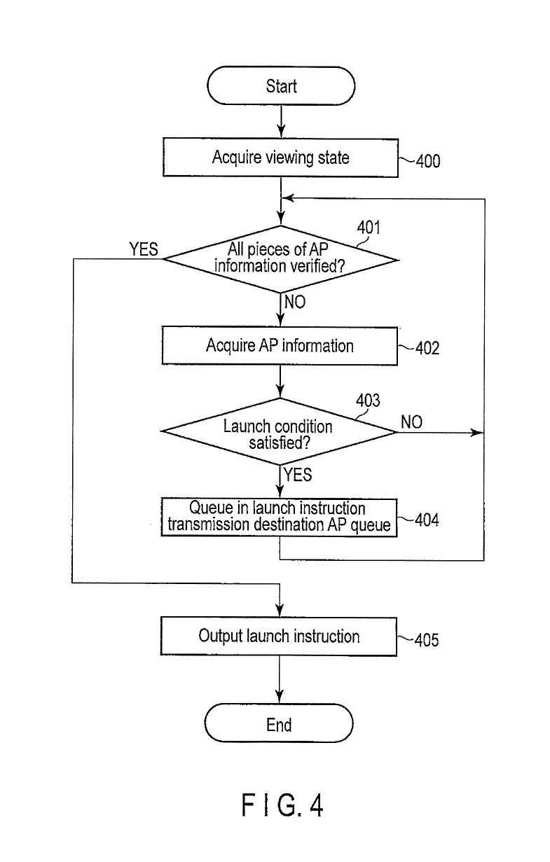

The operation of the system mainly including the controller 100 will be described below with reference to FIG. 3 and the flowchart shown in FIG. 4.

As shown in FIG. 3, when the user operates the remote controller 11, a program (video and audio) of a designated channel is being reproduced on a screen 12 of the TV set 10. A state will be assumed wherein the user is making zapping to search for a program other than the program which is being reproduced. As a result of zapping, since the user operates channel switching buttons on the remote controller 11 within a short period of time, program switching events frequently occur within the short period of time.

In the controller 100, the viewing information acquisition module 101 acquires the viewing information 110 indicating a zapping viewing state (user's viewing behavior) based on the operations on the remote controller 11 (block 400). That is, the controller 100 acquires the viewing information 110 indicating that channel switching events frequently occur.

The AP selection module 102 acquires application information (AP information) stored in the storage device 104 (block 402). The AP selection module 102 collates a launch condition included in that AP information with the viewing information 110 to verify whether or not a launch condition set in the AP information is satisfied (block 403). In this case, the launch condition is information which defines, for example, a zapping viewing state, as will be described later.

As a practical example, assume that a launch condition set in AP information of a “current program application” is “channel switching events occur Nc times or more when each program viewing time period is within Tc sec”. Tc and Nc in the launch condition are decided by, for example, experiments for inspecting the channel switching time period and the number of channel switching events in zapping.

The AP selection module 102 determines that the launch condition is satisfied as a result of collation with the zapping viewing information 110, and selects the AP information of the “current program application” (information of an application 200A) (block 403).

The launch instruction transmission module 103 queues a launch instruction corresponding to the selected AP information in a launch instruction transmission destination AP queue (block 404). Then, after verification of all pieces of AP information stored in the storage device 104 is complete, the controller 100 outputs the launch instruction 120 required to launch application 200A of the AP information from the launch instruction transmission destination AP queue (block 405). More specifically, the controller 100 transmits a packet of the launch instruction 120 onto the network 30. In this case, when a certain exclusive launch condition is satisfied, a launch instruction of an AP which does not correspond to that condition is deleted from the launch instruction transmission destination AP queue. Such exclusive launch condition is, for example, a condition that requires a newest last launch date and time of all the pieces of AP information.

On the other hand, if the controller 100 cannot find AP information whose launch condition is not satisfied with respect to the viewing information 110 from all the pieces of AP information stored in the storage device 104, it ends processing without outputting any launch instruction 120.

When the controller 100 transmits the packet of the launch instruction 120 onto the network 30, the mobile terminal 20 receives the packet of the launch instruction 120 via the network 30. As shown in FIG. 3, the mobile terminal 20 is installed with, for example, three types of applications 200A to 200C as the application 200. When the mobile terminal 20 receives the launch instruction 120 corresponding to application 200A, application 200A is launched. On the other hand, remaining applications 200B and 200C are not launched.

In this case, application 200A is, for example, the “current program application”. As shown in FIG. 8, application 200A has a function of displaying a list of programs which are on the air at the current time on the screen of the mobile terminal 20 and starting reproduction of a program that the user wants to view when the user taps a cell of that program with the finger.

It is optimal to select the current program application 200A which allows the user to view a list of programs based on an estimation that when the user makes zapping, he or she wants to confirm program content of other channels at the same time. In the controller 100, the AP selection module 102 selects AP information including a launch condition that launches an application upon detection of zapping based on the viewing information 110.

As described above, the controller 100 includes the storage device 104 which stores AP information. AP information is provided for each of applications 200A to 200C installed in each mobile terminal 20. Each of applications 200 which are installed in different mobile terminals and have the same function has independent AP information.

In this case, upon verification of a launch condition of AP information (block 403), if a plurality of pieces of AP information satisfy the launch condition at the same time, the AP selection module 102 preferentially selects AP information with a larger launch priority value based on those included in the respective pieces of AP information. When the launch priority values assume the same value, the AP selection module 102 may select AP information verified earlier. In place of handling binary data indicating whether or not the launch condition is satisfied, a method of deciding a launch priority order of AP information more finely by handling multi-valued data indicating satisfied degrees of the condition step by step may be used.

When an application as a target to which the launch instruction 120 is to be transmitted is fixed, the controller 100 records in advance AP information in the storage device 104 as information which does not depend on a user environment. The controller 100 may acquire AP information from a server via the network, and may store it in the storage device 104.

The user manually or automatically sets an IP address of the mobile terminal 20 as environment-dependent information in the controller 100. In order to automatically obtain the IP address of the mobile terminal, the controller 100 uses a general method used upon conducting a device search on the network. If no application as a target of the launch instruction 120 transmitted from the controller 100 is installed in the mobile terminal 20 of the user, nothing is launched in the mobile terminal 20, thus posing no problem.

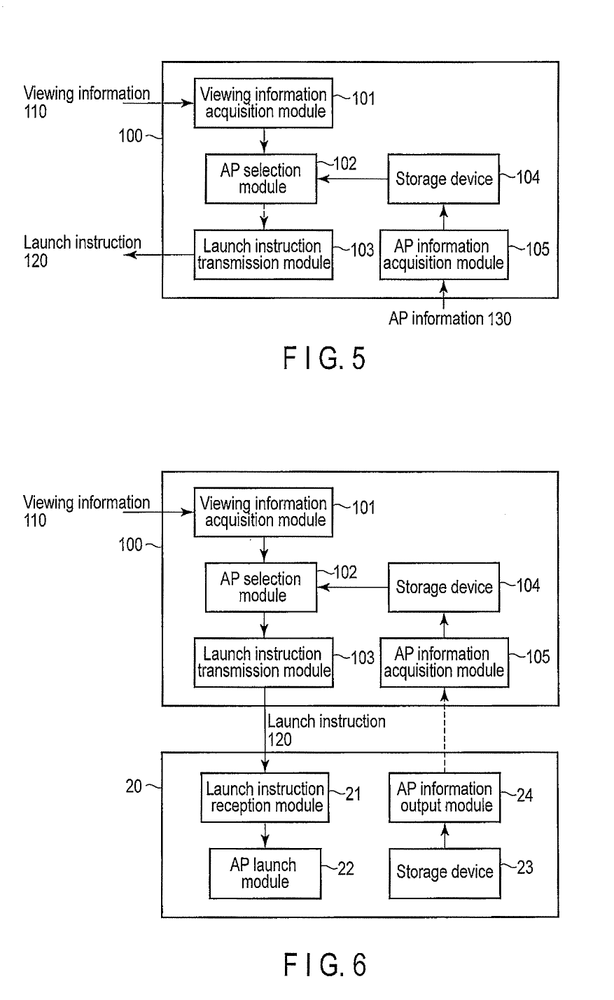

FIGS. 5 and 6 are block diagrams showing application examples of this embodiment.

As shown in FIG. 5, the controller 100 has an AP information acquisition module 105. The AP information acquisition module 105 externally acquires AP information of a target application, and stores the acquired AP information in the storage device 104. More specifically, the AP information acquisition module 105 has a connection terminal of a USB memory, and inputs AP information from the connected USB memory.

As shown in FIG. 6, the mobile terminal 20 includes a launch instruction reception module 21, AP launch module 22, storage device 23, and AP information output module 24. The mobile terminal 20 receives a launch instruction from the controller 100 by the launch instruction reception module 21. The AP launch module 22 launches the application 200 (one of applications 200A to 200C) according to the launch instruction received by the launch instruction reception module 21.

The mobile terminal 20 outputs AP information stored in the storage device 23 to the controller 100 via the AP information output module 24. The controller 100 acquires the AP information from the mobile terminal 20 via the AP information acquisition module 105, and stores the acquired AP information in the storage device 104.

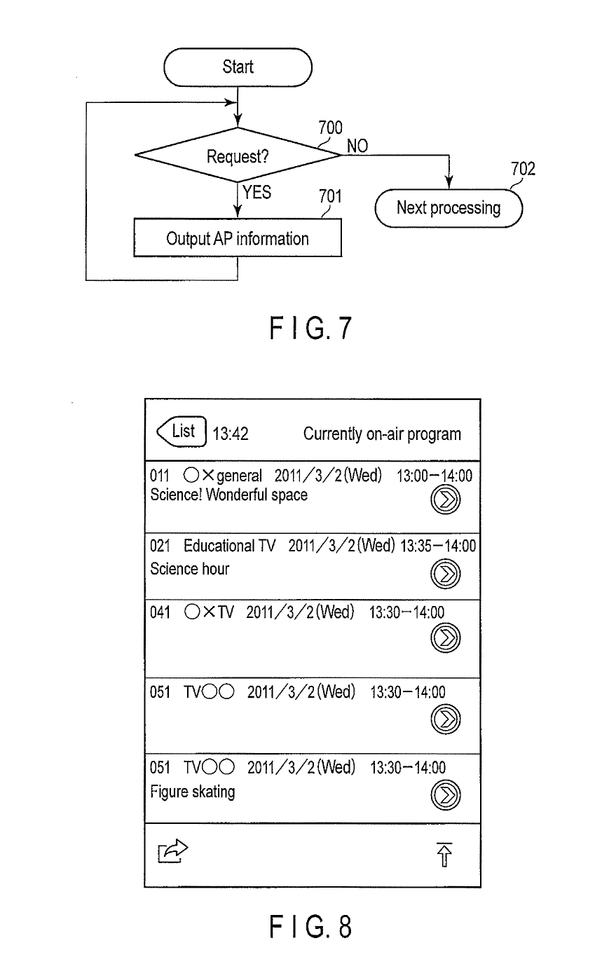

As shown in FIG. 7, the mobile terminal 20 outputs AP information to the controller 100 via the AP information output module 24 in response to a request from the controller 100 (YES in block 700, block 701). In this case, the mobile terminal 20 repetitively outputs the AP information every time a request is received from the controller 100 at a given time interval. Of course, the mobile terminal 20 executes predetermined interrupt processing or the like between an interval of requests (block 702). On the other hand, when the mobile terminal 20 receives the launch instruction 120 from the controller 100 during its operation, it launches the designated application 200A corresponding to the launch instruction 120.

As described above, the user need not make any setting operations about AP information. An AP information acquisition timing of the controller 100 is a timing immediately after the controller 100 is activated or once per given period (several hours to one day).

The launch condition of the application included in the AP information will be described below.

The launch condition of the application is defined by a description of a given format. The controller 100 and mobile terminal 20 commonly use the launch condition described using that format. FIG. 10 shows a practical example of the given format.

For example, a launch condition of the current program application 200A is defined as follows.

IF((the number of times of occurrence of EVch>5)WITHIN 10 sec) (1)

This conditional statement (1) means that it is true when the number of times of occurrence of channel change events EVch reaches six or more within 10 sec. This conditional statement (1) is an example of the launch condition required to detect a zapping viewing state (viewing information 110).

The controller 100 installs, in advance, a function (program) required to execute fragmentary processing (processing for detecting channel switching events EVch), which can be an element of the launch condition, so as to execute that processing in association with the given format.

On the other hand, the applications 200 installed in the mobile terminal 20 have launch conditions according to the given format. The controller 100 collects these launch conditions, and uses them in determination upon transmission of a launch instruction to each application.

The launch condition of an application need not be included in the application itself, but the controller 100 may have launch conditions of all released applications. In this case, each application has an identifier of a launch condition so as to inform the controller 100 of which launch condition is true to transmit a launch instruction to itself. The controller 100 may collect identifiers of launch conditions and may periodically determine true/false of the launch conditions indicated by the collected identifiers.

### Second Embodiment

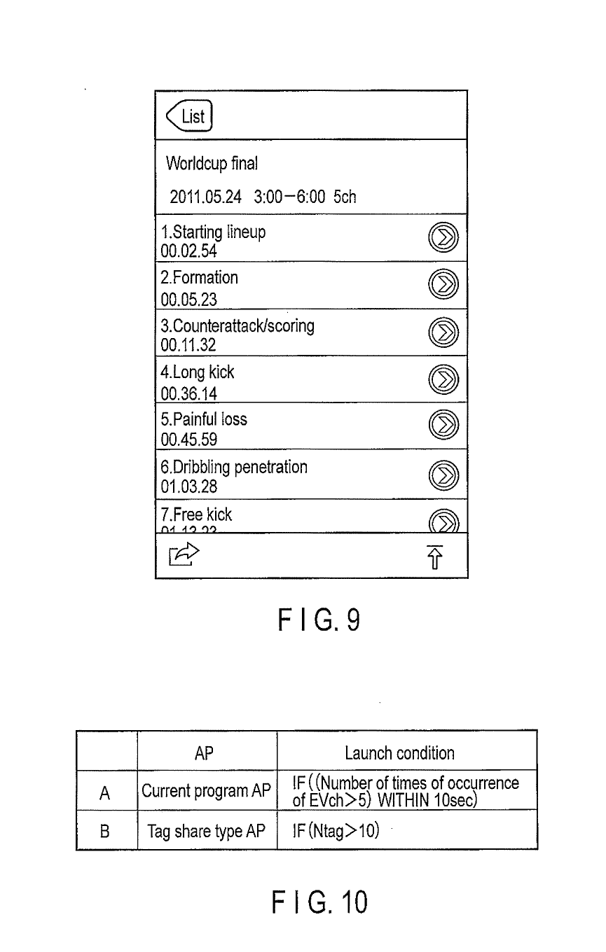

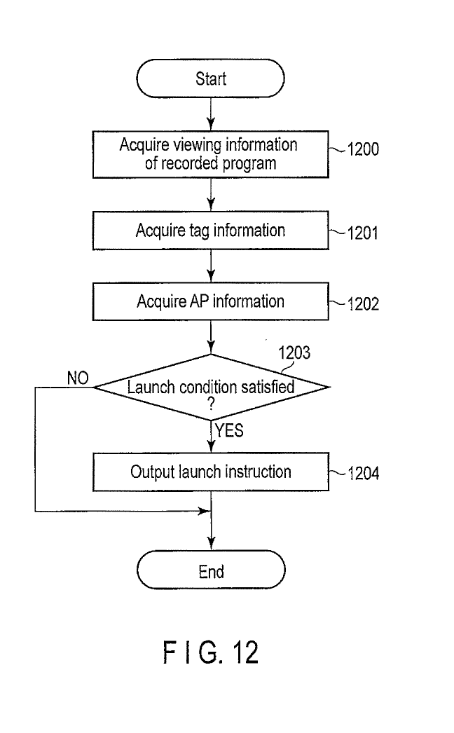

The second embodiment will be described below with reference to FIGS. 9 and 10, and the flowchart shown in FIG. 12. Note that the arrangements of the system, controller 100, and mobile terminal 20 are the same as those shown in FIGS. 1, 2, 5, and 6 described above.

The first embodiment has assumed the case in which as the application 200, current program application 200A is launched to have a zapping viewing state (user's viewing behavior) as a trigger. The second embodiment will assume a case in which a tag share type application 200C is to be launched.

A “tag share” function is that which allows the user to set a tag at an arbitrary position of a program in advance, and reproduces the program from the tag set position later. The “tag” is something like a bookmark set on a timeline of video reproduction, and can be freely named by the user. For example, when the user sets a tag at a position of a goal scene of a soccer program, and gives a name “goal”, he or she can easily view that program from the goal scene at the time of later reproduction. The tag share function allows users to share tags set by individual users. Tags set by users are collected on a server, and other users who view the same program can use these tags.

FIG. 9 shows a display example on the screen of the mobile terminal 20 by the tag share type application 200C. That is, application 200C acquires tags attached to a video from an external server, and displays a list of tags on the screen of the mobile terminal 20. The user can reproduce the video from the reproduction position of a tag when he or she taps that tag item. It can be estimated that a program with many tags has higher visibility than that without a tag.

The operation of the controller 100 with the arrangement shown in FIG. 6 will be described below with reference to the flowchart shown in FIG. 12.

When the user begins to view a recorded program, the viewing information acquisition module 101 of the controller 100 acquires viewing information 110 indicating a viewing state of the recorded program (block 1200). The viewing information acquisition module 101 acquires tag information of that recorded program via the network (block 1201).

The AP selection module 102 acquires application information (AP information) stored in the storage device 104 (block 1202). The AP selection module 102 collates a launch condition included in that AP information with the viewing information 110 to verify whether or not the launch condition set in that AP information is satisfied (block 1203). In this embodiment, the launch condition is a tag share type launch condition, as will be described later.

The launch instruction transmission module 103 outputs a launch instruction 120 required to launch application 200C of the AP information selected by the AP selection module 102 (block 1204). Thus, as shown in FIG. 3, when the mobile terminal 20 receives the launch instruction 120 corresponding to application 200C, the tag share type application 200C is launched.

As shown in FIG. 10, the launch condition of the tag share application 200C is defined by the following given format.

IF(Ntag>10) (2)

This conditional statement (2) means that it is true when the number Ntag of tags attached to a recorded program which is being reproduced is 11 or more. This conditional statement is an example of a condition required to detect a viewing state “a recorded program attached with many tags is being reproduced”. The controller 100 installs, in advance, a function (program) required to execute fragmentary processing (processing for acquiring the number Ntag of tags attached to a recorded program which is being reproduced), which can be an element of the launch condition, so as to execute that processing in association with the given format.

More specifically, the launch condition of the tag share type application is defined so that a video having 11 or more attached tags begins to be reproduced. In this case, assume that the value “11” is an average value of the numbers of tags attached to respective videos by the current tag share function. When the number of tags acquired by the viewing information acquisition module 101 is 11 or more, the launch condition is satisfied, and the launch instruction transmission module 103 transmits the launch instruction 120 of the tag share type application 200C.

The AP information of the tag share type application 200C includes information associated with argument information to be included in a launch instruction. The argument information is a value to be passed to the mobile terminal 20 via the launch instruction when the application is launched, and is information which designates how to launch the application. More specifically, the argument information is an identifier of a video to be reproduced. The video identifier is unique information on the tag share function, and specifies a video. Upon reception of the launch instruction, the mobile terminal 20 launches the tag share type application 200C. In this case, based on the argument information, the mobile terminal 20 automatically transits to a display screen of a tag list of a video indicated by the video identifier of the argument information, as shown in FIG. 9.

[Modification]

In the first and second embodiments, when the user possesses a plurality of mobile terminals, the controller 100 may automatically select a mobile terminal and transmit a launch instruction to the selected mobile terminal. In this case, the mobile terminal 20 which launches the application is preferably located in user's sight. For this reason, AP information to be acquired by the controller 100 may include information indicating whether or not the mobile terminal 20 installed with that application is suited to receive the launch instruction.

A method of deciding whether or not each mobile terminal is suited to receive the launch instruction is set in advance by the user by operating the mobile terminal. Using a brightness sensor of each mobile terminal, it is determined that a mobile terminal having a given brightness level or lower is not suited to receive the launch instruction. Furthermore, the previously used mobile terminal is preferentially set to receive the launch instruction. Alternatively, all mobile terminals may be allowed to receive the launch instruction several times after the TV is activated unless the user makes a reception inhibition setting or a power switch is off. For example, the AP selection module 102 selects the current program application. In this case, when a plurality of mobile terminals are installed with that application, all the mobile terminals may launch the application. After the application is launched, only the mobile terminal on which the user operates the application may be allowed to receive the launch instruction, and other mobile terminals may be inhibited from receiving the launch instruction until the power switch of the TV is turned off.

Not only when there are a plurality of mobile terminals but also when only one mobile terminal is used, if the user does not use any function, the application function may be automatically disabled. When no user's operation input is generated for a predetermined period of time since the application of a certain mobile terminal is automatically launched, it may be determined that the automatic launch function of that mobile terminal is not used, and the mobile terminal may be inhibited from receiving the launch instruction until the power switch of the TV is turned off.

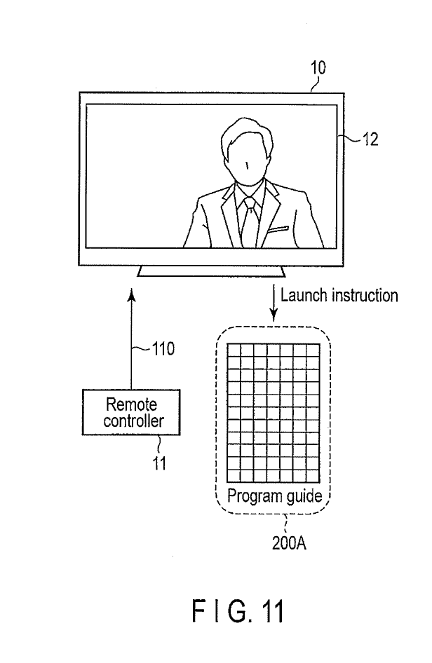

Note that in the first embodiment, as shown in FIG. 11, when the mobile terminal 20 receives a launch instruction from the controller of the TV set 10, it launches the designated application 200A corresponding to the launch instruction 120. In this case, the application to be launched may be that which is set by the user in either the controller 100 or mobile terminal 20. That is, when the launch instruction includes information which designates an application to be launched, the user sets that information in the controller 100. On the other hand, when the controller 100 transmits a launch instruction which does not include any information that designates an application to be launched, the user sets that information in the mobile terminal 20.

An application to be launched may be that which was used lastly. In this case, information of an application which was used lastly is recorded in either the controller 100 or mobile terminal 20 without requiring any user's manual settings.

Note that in the first and second embodiments, as the application 200, the current program application and tag share type application are assumed. However, the present embodiments are not limited to them. For example, as the application 200, that which displays a video recording reservation list, that which displays hot program rankings, that which displays a program related keyword list, or the like may be assumed.

To summarize, the TV set 10 can automatically select and launch an application suited to a user's viewing state (situation). Therefore, the user can obtain an optimal operation environment of a video reproduction apparatus without recognizing functions of all applications installed in the mobile terminal 20.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus comprising:
a viewing information acquisition module configured to acquire viewing information indicating a viewing state of a video reproduction apparatus;
an application setting module configured to set an application used to execute designated data processing associated with an operation of the video reproduction apparatus based on the viewing information; and
an output module configured to output a launch instruction required to launch the application set by the application setting module.

2. The data processing apparatus of claim 1, further comprising:
a storage device configured to store application information including information required to specify an application and information indicating a launch condition,
wherein the application setting module is configured to collate the viewing information with the launch condition and to select application information which satisfies the launch condition with respect to the viewing information from the storage device.

3. The data processing apparatus of claim 2, further comprising:
an application information acquisition module configured to acquire the application information via a network, and to store the acquired application information in the storage device.

4. The data processing apparatus of claim 3, wherein the application information acquisition module is configured to acquire the application information from an electronic device connected to the network and to store the acquired application information in the storage device.

5. The data processing apparatus of claim 4, wherein the application information acquisition module is configured to acquire the application information from the electronic device connected to the network at an activation timing of the data processing apparatus or at predetermined time intervals, and to store the acquired application information in the storage device.

6. The data processing apparatus of claim 1, wherein the output module is configured to transmit the launch instruction to one or a plurality of electronic devices connected to a network.

7. A data processing system comprising:
a data processing apparatus that comprises (i) a viewing information acquisition module configured to acquire viewing information indicating a viewing state of a video reproduction apparatus, (ii) an application setting module configured to set an application used to execute designated data processing associated with an operation of the video reproduction apparatus based on the viewing information, and (iii) an output module configured to output a launch instruction required to launch the application set by the application setting module;
an electronic device; and
a data communication module configured to make a data communication between the data processing apparatus and the electronic device,
wherein the electronic device comprises:
a module configured to receive the launch instruction; and
a module configured to launch an application according to the received launch instruction.

8. The data processing system of claim 7, wherein the data processing apparatus comprises a storage device configured to store application information including information required to specify an application and information indicating a launch condition, and
the application setting module is configured to collate the viewing information and the launch condition, and to select application information which satisfies the launch condition with respect to the viewing information from the storage device.

9. The data processing system of claim 8, wherein the data processing apparatus comprises an application information acquisition module configured to acquire the application information, and
the electronic device comprises a module configured to output the application information to the application information acquisition module.

10. The data processing system of claim 9, wherein the data processing apparatus is configured to control the application information acquisition module to acquire, from the electronic device, the application information at an activation timing of the data processing apparatus or at predetermined time intervals.

11. The data processing system of claim 7, wherein the data processing apparatus is configured to be included in the video reproduction apparatus,
the electronic device is configured to be a mobile terminal installed with the application, and
the information communication module is configured to connect the data processing apparatus and the electronic device via a network.

12. A method of making an operation of a video reproduction apparatus, the method comprising:
acquiring viewing information indicating a viewing state of the video reproduction apparatus;
setting an application required to execute designated data processing associated with the operation based on the viewing information; and
outputting a launch instruction required to launch the set application.

13. The method of claim 12, wherein the acquiring of the viewing information, setting of the application and outputting of the launch instruction are performed by a hardware controller.
